(19) United States
(12) Patent Application Publication
(10) Pub. No.: US 2022/0127013 A1
(43) Pub. Date: Apr. 28, 2022

(54) SECURE AVIONCS WIRELESS ACCESS POINT DEVICE WITH HEAT SINK ENCLOSURE

(71) Applicant: CCX Technologies, Ottawa (CA)

(72) Inventor: Charles Eidsness, Ottawa (CA)

(21) Appl. No.: 17/507,030

(22) Filed: Oct. 21, 2021

Related U.S. Application Data
(60) Provisional application No. 63/104,712, filed on Oct. 23, 2020.

(51) Int. Cl. B64D 45/00; H04L 29/06

(52) U.S. Cl. CPC B64D 45/0015; H04L 63/1425; H04L 63/1416

(57) ABSTRACT

The present application provides a thermal design of device enclosures for aviation cyber security hardware products. A secure avionics wireless access point device with heat sink enclosure is provided that provides security processing and interconnectivity while being small in size, not requiring supplemental cooling and may operate outside of the aviation pressure cabin. The device may be installed in-line with networking devices and avionics to monitor and protect an aircraft's onboard network.

### TECHNICAL FIELD

The present invention relates to heat sinks for use with aircraft devices. More particularly, the invention relates to a heat sink enclosure for a secure avionics device.

### BACKGROUND

Conventional solutions in the aviation cybersecurity domain including using regular (e.g. ground use) wireless access points and encasing them in standard size aviation boxes. The conventional avionics wireless access point are large, use a large amount of power, are not designed to operate outside the environmentally controlled cabin and require cooling systems (e.g. fans) that add to their power requirements and mass. Higher-capability systems contained within lower mass and reduced size devices are needed to support the increase in frequency and sophistication of aviation cyberattacks.

### SUMMARY

The present application provides a secure avionics wireless access point device with heat sink enclosure (the “device”). The device of the present application is smaller than conventional solutions. The self-contained design of the device provides adequate processing and interconnectivity while significantly reducing power and system cooling requirements. The device of the present application may be used for conventional aviation cyber security, but also for other applications including for example un-piloted systems that include drones, emerging autonomous air vehicles and satellite systems.

The present application provides an innovative thermal design for aviation housing of cyber security hardware products. The device is designed to provide increased processing capacity than existing conventional products and the device enclosure is small, does not require supplemental cooling, and can be environmentally certified to operate outside of the aviation pressure cabin.

The device may be installed in-line with networking devices and avionics to monitor and protect an aircraft's onboard network.

An avionic wireless access point device comprising a housing and one or more electronic components contained within the housing, wherein the housing functions as a heat sink. The device is operable in non-pressurized environments. As well, the housing is made of a high thermal conductivity material to dissipate heat. Also, the external surface of the housing has a plurality of fins to dissipate heat.

An wireless access point device for use with an avionic system, the device comprising a heat sink enclosure, a communications subsystem contained within the enclosure; and a processor contained within the enclosure. The processor is configured to review incoming communications to the avionic system for cybersecurity threats; and transmit, to a ground server, an alert regarding a detected cybersecurity threat.

### BRIEF DESCRIPTION OF THE DRAWINGS

FIG. 1 is a perspective view of the device in accordance with one example embodiment of the present disclosure;

FIG. 2 is a perspective view of the device with the top plate removed in accordance with one example embodiment of the present disclosure;

FIG. 3 is an exploded view of the device in accordance with one example embodiment of the present disclosure;

FIG. 3A is a diagram showing PCI board with connections in accordance with one example embodiment of the present disclosure;

FIG. 4 is a second exploded view of the device in accordance with one example embodiment of the present disclosure;

FIG. 5A is a perspective view of the side heat sink of the device enclosure in accordance with one example embodiment of the present disclosure;

FIG. 5B is a top view of the side heat sink of the device enclosure in accordance with one example embodiment of the present disclosure;

FIG. 5C is a side view of the side heat sink of the device enclosure in accordance with one example embodiment of the present disclosure;

FIG. 5D is a back view of the side heat sink of the device enclosure in accordance with one example embodiment of the present disclosure;

FIG. 6A is a perspective view of the top plate heat sink of the device enclosure in accordance with one example embodiment of the present disclosure;

FIG. 6B is a top view of the top plate heat sink of the device enclosure in accordance with one example embodiment of the present disclosure;

FIG. 6C is a side view of the top plate heat sink of the device enclosure in accordance with one example embodiment of the present disclosure;

FIG. 6D is a back view of the top plate heat sink of the device enclosure in accordance with one example embodiment of the present disclosure;

FIG. 6E is a front view of the top plate heat sink of the device enclosure in accordance with one example embodiment of the present disclosure;

FIG. 7A is a perspective view of the back plate heat sink of the device enclosure in accordance with one example embodiment of the present disclosure;

FIG. 7B is a top view of the back plate heat sink of the device enclosure in accordance with one example embodiment of the present disclosure;

FIG. 7C is a side view of the back plate heat sink of the device enclosure in accordance with one example embodiment of the present disclosure;

FIG. 7D is a back view of the back plate heat sink of the device enclosure in accordance with one example embodiment of the present disclosure;

FIG. 7E is a front view of the back plate heat sink of the device enclosure in accordance with one example embodiment of the present disclosure;

FIG. 8 is diagram showing the device in an aircraft environment in accordance with one example embodiment of the present disclosure;

FIG. 9 is a system diagram showing the device's connectivity to other components in accordance with one example embodiment of the present application;

FIGS. 10A to 10D are thermal heat maps of the device in use in accordance with an example embodiment of the present application; and

FIG. 11 is a perspective view of the device in accordance with another example embodiment of the present disclosure.

### DETAILED DESCRIPTION

To the accomplishment of the foregoing and related ends, certain illustrative aspects are described herein in connection with the following description and the annexed drawings. These aspects are indicative of the various ways in which the principles disclosed herein can be practiced. Other advantages and novel features will become apparent from the following detailed description when considered in conjunction with the drawings.

Thermal dissipation is a significant factor in avionic design: this factor drives product size, power requirements and mass. The secure avionics wireless access point device of the present application has a small mechanical enclosure that has been designed to account for the thermal map of components necessary to manage advanced cyber-security management and processing. All heat generating electronic components are designed to be placed on the top or bottom of the enclosure. For example, the electronic components are positioned within the device in close proximity to the top and bottom surfaces of the housing. This, together with a heat spreader design, allows for a near-uniform thermal spread throughout the enclosure. The device of the present application meets the Environmental Conditions and Test Procedures for airborne equipment standard RTCA DO-160. The RTCA DO-160 standard tests airborne equipment across a variety of criteria including for example temperature, humidity, vibration, power input, radio frequency susceptibility, lightning and electrostatic discharge. Sufficient sealing of the device is incorporated in the design to meet the drip test standards of RTCA DO-160. Sealing of the device of the present application is achieved for example with the large overlap with the top and bottom plates over the side blocks; the ledges on the back and front plates to the top and bottom plates; and tight manufacturing tolerances provided by using machined parts.

As a result, the device may be used and installed inside a pressurized aircraft cabin as well as may be used and installed outside the pressurized aircraft cabin (e.g. non-pressurized environments). Although the example embodiments show a secure avionics wireless access point device, the heat sink enclosure of the present application may be utilized for housing other electronic and communication devices, such as for example a flight controller.

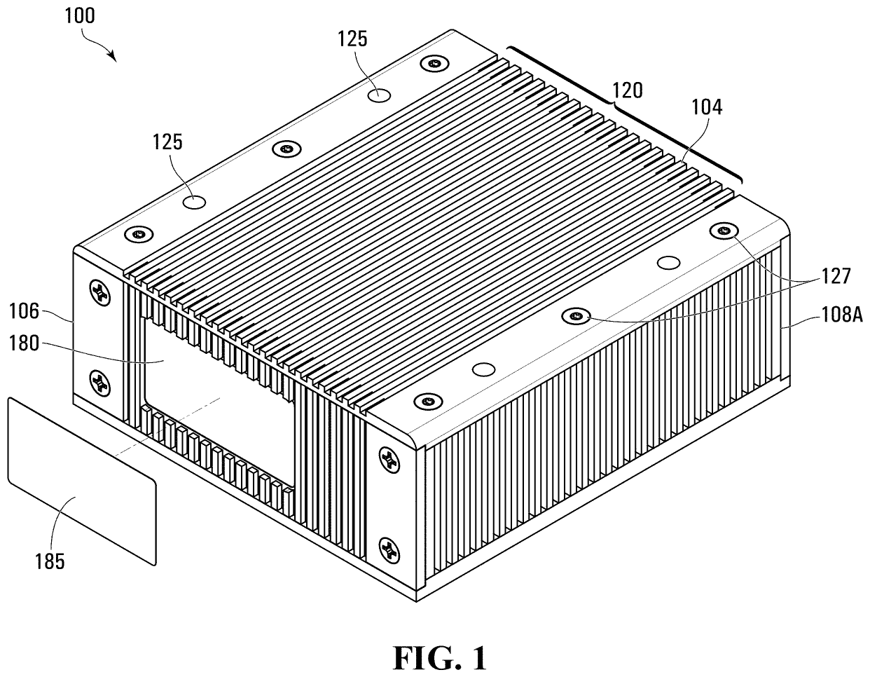

FIG. 1 illustrates the secure avionics wireless access point device 100 in accordance with an example embodiment of the present application. The enclosure (e.g. housing) of the device 100 includes a top plate 104, a bottom plate (not shown), a first side plate 108A, a second side plate (not shown), a back plate 106 and a front plate (not shown). The plates of the enclosure may also be referred to as panels. The enclosure of the device 100 functions as a heat sink for the internal components of the device 100. The enclosure of the device 100 is made of metal that has a high thermal conductivity to dissipate heat. The enclosure of the device 100 may be made of, for example, aluminum or copper. In an example embodiment, the enclosure of the device 100 is made of aluminum 6061. In other embodiments, the enclosure of the device 100 may be made of a combination of metals that have high thermal conductivity, for example the enclosure may be made of both aluminum and copper elements. The enclosure of the device 100 may be manufactured via a computer numerical control (CNC) machine.

The top plate 104 has a series of fins 120, one or more mounting holes 125 and one or more securing means 127. The fins 120 create a large surface area to facilitate the dissipation of heat from the internal components of the device 100. The first side plate 108A, the second side plate and the back plate 106 also have fins. The one or more mounting holes 125 are used to mount the device 100 to a mounting base or plate on the aircraft or other environment. The mounting holes through the body of the device 100 are unique and facilitate the device 100 being of a smaller size and weight than conventional devices. As well, conventional devices employ additional flanges for attachment of devices to an aircraft that add to weight and size. The mounting holes of the device 100 of the present application pass through the top plate 104, the side plates 108A,108B and bottom plate 105 to attach the device 100 to an aircraft structure or mounting plate without the need for any additional attachment means. The one or more securing means 127 secure the top plate 104 to the first side plate 108A and to the second side plate. In an example embodiment, the top plate 104 is secured to the side plates using screws. However, other securing means may be used for example thermal adhesives. The back plate 106 may have a surface recess 180 for receiving a plate or other covering 185. For example, the plate or covering may be used to display branding or other information (e.g. technical specifications) relating to the device 100.

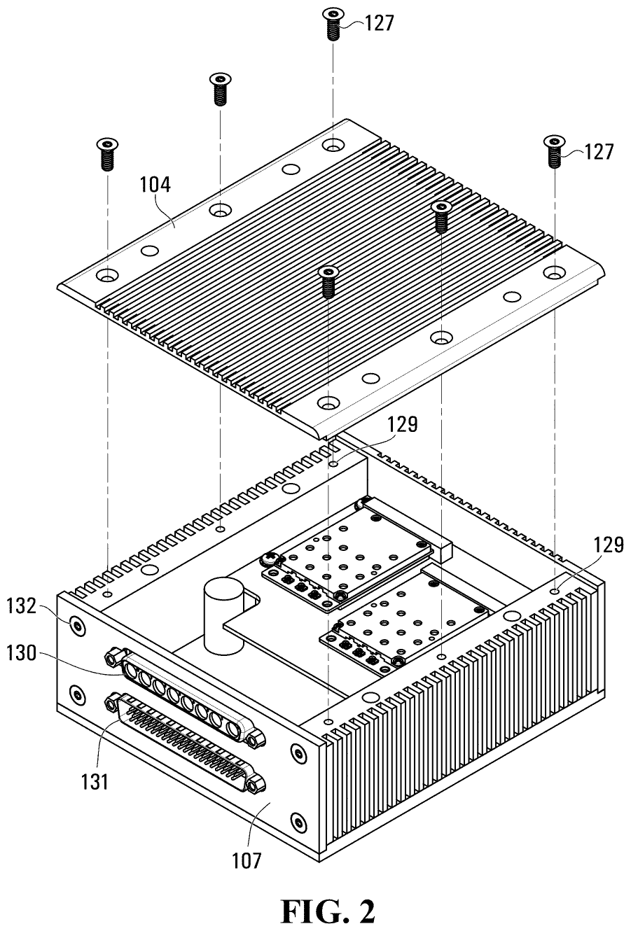

FIG. 2 shows the device 100 with the top plate 104 removed in accordance with an example embodiment of the present application. The enclosure of the device 100 further includes a front plate 107 with one or more pin connections 130, 131. The front plate 107 has one or more securing means 132 for attaching the front plate 107 to the first side plate 108A and the second side plate. In the example embodiment shown, the top plate 104 is secured to the first side plate 108A and the second side plate using screws 127 that pass through a set of holes 128 on the top plate 104 and a set of holes 129 on the first and second side plates.

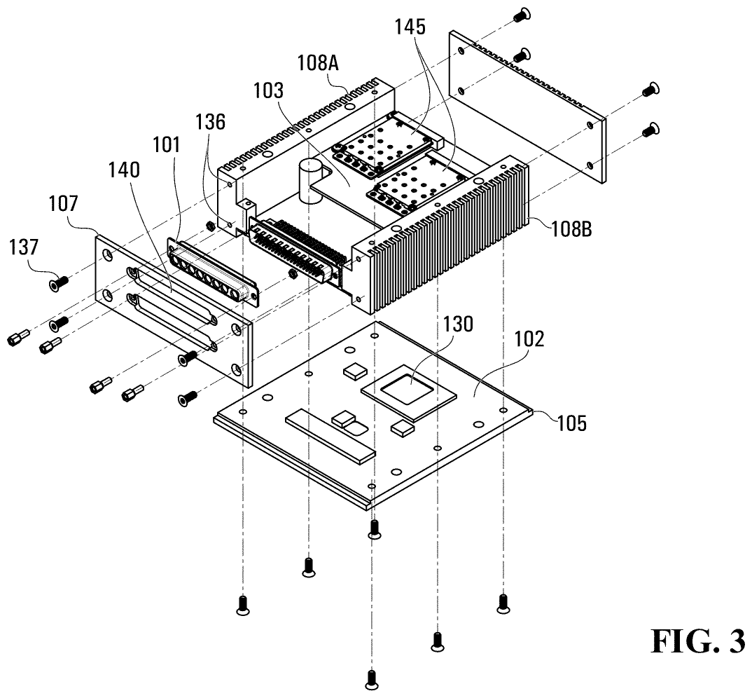

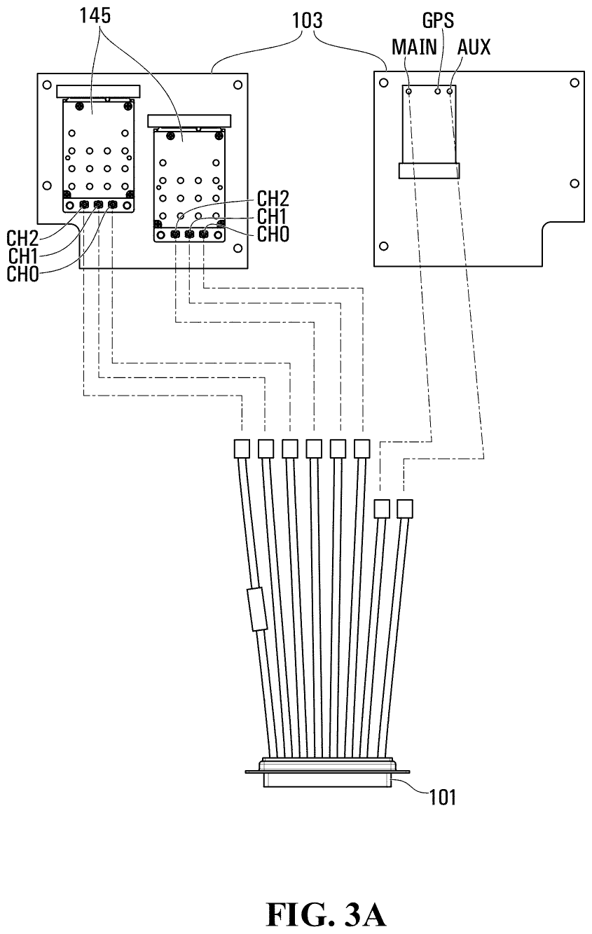

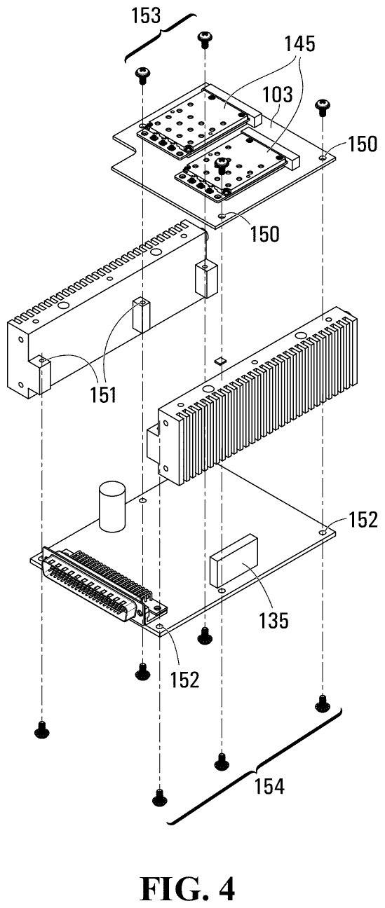

FIG. 3 shows an exploded view of the device 100 according to an embodiment of the present application. FIG. 3 shows the bottom plate 105, the front plate 107 and the second side plate 108B. The external side (not shown) of the bottom plate 105 is generally a flat surface without heat sink fins. The external side of the bottom plate 105 is the surface of the device 100 that is attached to an aircraft structure or a mounting plate. The direct contact between the bottom plate 105 and the aircraft structure provides a source of heat transfer as well as provides a simple mounting method of the unit. A main circuit board 102 is attached or affixed onto the bottom plate 105. The main circuit board 102 may include various electronic components including for example a processor, a memory such as a solid-state drive (SSD) storage and random access memory (RAM). The main circuit board 102 has the functionality (e.g. wireless interface) of a gateway to receive and transmit information via satellites, radio frequency (RF) and wireless networks. The device 100 has a transmitter and a receiver to facilitate wireless communication (e.g. a communication subsystem). In the example embodiment, at a surface area 130 thermal paste or adhesive is applied to attach a peripheral component interconnect (PCI) board 103 to the main circuit board 102. Also as shown in FIG. 4, in the example embodiment on the main circuit board 102 there is a protrusion 135 that acts a connector or connection point for the main circuit board 102 and the PCI board 103. In the example embodiment shown in FIG. 3, each of the first and second side plates 108A, 108B has a series of holes 136 along its edges that receive a plurality of screws 137 to secure the front plate 107, the back plate 106, the top plate 104 and the bottom plate 105. Other securing means may be used to assemble and connect of the plates of the device 100. The front plate 107 has one or more openings 140 to receive one or more pin connectors 101. In the example embodiment, the pin connector 101 is a coaxial cable connector for wireless communication such as for example LTE and WiFi. In other embodiments, the connector 101 may be a different pin connector or different connection type such as for example USB, HDMI, RS232. The circuit board 102 and the PCI board 103 within the device 100 may be arranged and positioned differently than the example shown in FIG. 3.

One or more plug-in cards 145 are attached on the top surface of the PCI board 103. FIG. 3A shows a diagram showing the PCI board 103 with the pin connections from the pin connector 101 to the plug-in cards 145 in accordance with one example embodiment of the present disclosure. The top left portion of FIG. 3A shows the top surface of the PCI board 103 and the top right portion shows the bottom surface of the PCI board 103.

FIG. 4 illustrates is a second exploded view of the device 100 in accordance with one example embodiment of the present disclosure. As shown in FIG. 4, there are a series of holes 150 on the PCI board 103 that correspond with the series of holes 151 on the first and second side plates 108A, 108B, and with the series of holes 152 on the main circuit board 102 and the bottom plate 105. The PCI board 103 is secured to the first and second side plates 108A, 108B with screws 153. The main circuit board 102 and the bottom plate 105 are secured to the first and second side plates 108A,108B with screws 154. In other embodiments, the plates may be secured with a different combination of holes and screws or with other securing means. The protrusion 135 is an electronic connector or connection point for the main circuit board 102 and the PCI board 103.

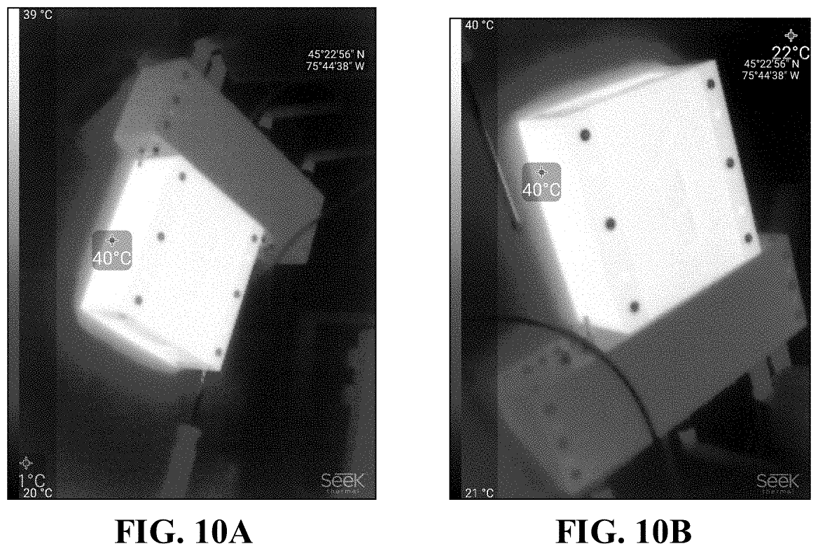

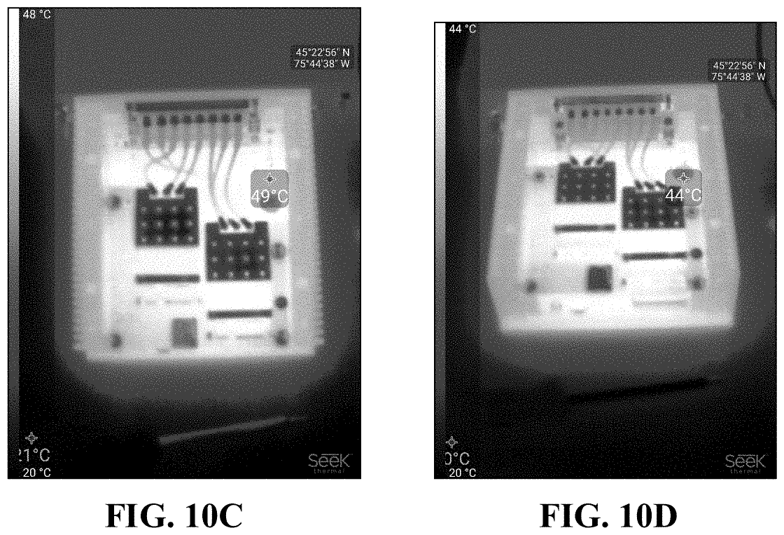

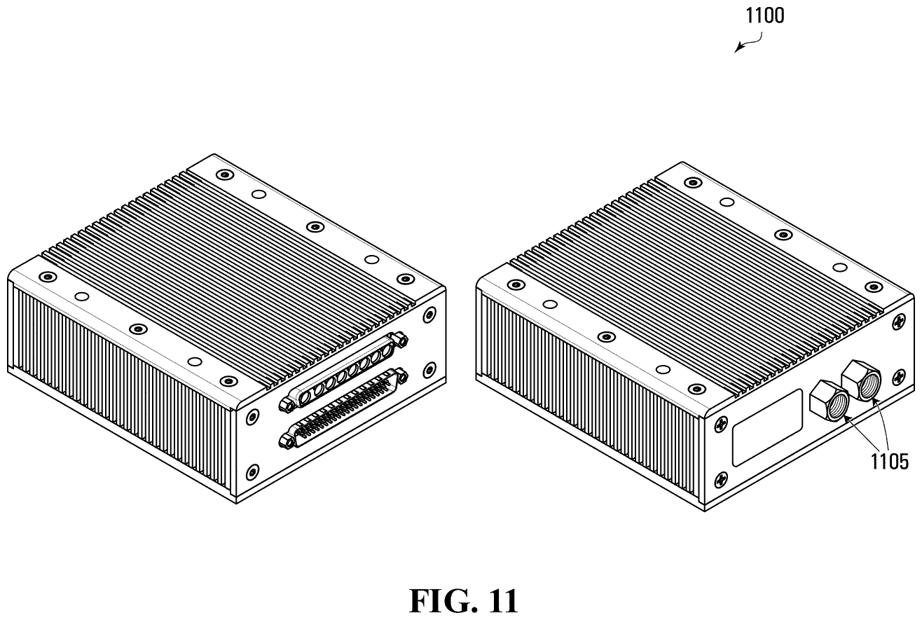

FIG. 10A to 10D show thermal heat maps of the device 100 in use according to an example embodiment of the present application. The temperature of the point shown on the enclosure of the device 100 is 40° C. for FIGS. 10A and 10B, 44° C. for FIG. 10C and 49° C. for FIG. 10D.The initial design of the device 100 was tested using a thermal load (e,g, power resistor) to simulate the device 100 in use and design of the device 100 was adjusted accordingly to optimize heat transfer. The top plate 104 of the device 100 acts as the main heat dissipater as it has the largest surface area. In some embodiments, the side plates 108A, 108B function both as a heat-pipe and as a heat-sink (e.g. hybrid heat-pipe/heat-sink). The placement of one or more internal electronic components in the device 100 such as for example the PCI board 103 and the main circuit board 102 are designed to maximize the internal 3D space in the device 100. The device 100 utilizes PCBs with space optimisation comprises and incorporates a stacked placement structure of PCBs to facilitate sufficient room for heat-sinks. As well, the top plate 104 is recessed into the enclosure to provide adequate space for PCBs. As shown in FIGS. 10A to 10D, there is a near uniform thermal spread throughout the surface of the enclosure of the device 100.

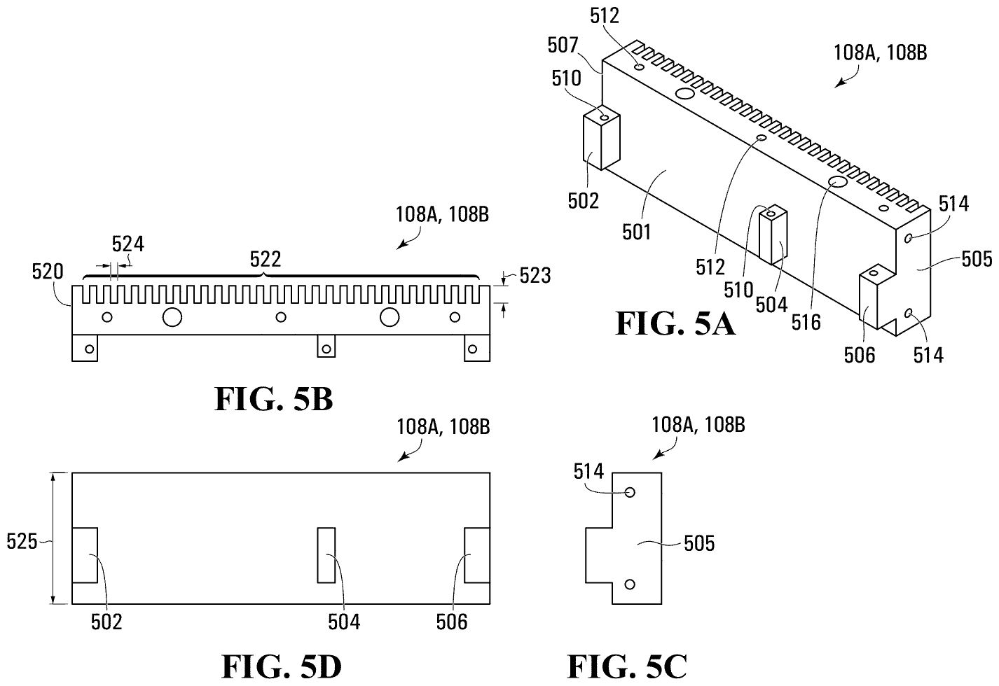

FIG. 5A is a perspective view of the first and second side plates 108A, 108B of the device 100 enclosure in accordance with one example embodiment of the present disclosure. As shown in FIG. 5A, the first and second side plates 108A, 108B have one or more protrusions 502, 504, 506 that extend from the interior side 501 of the sides plates 108A, 108B. The top surface of each of the one or more protrusions 502, 504, 506 each have holes 510 that align with the holes on the PCI board 103 and the main circuit board 102 to secure the boards 102, 103 to the side plates 108A, 108B using screws (not shown). Each of the first and second side plates 108A, 108B have one or more holes 512 on its top surface 503 that align with holes on the top plate 104 that are used to secure the top plate 104 to the side plates 108A, 108B. As well, each of the first and second side plates 108A, 108B have one or more holes 514 on its first side surface 505 that align with holes on the back plate 106 that are used to secure the back plate 106 to the side plates 108A, 108B. Similarly, each of the first and second side plates 108A, 108B have one or more holes (not shown) on its second side surface 507 that align with holes on the front plate 107 to secure the front plate 107 to the side plates 108A, 108B. Also, the first and second side plates 108A, 108B have a series of holes 516 that are used to mount the device 100 to its external environment (e.g. on the aircraft).

FIG. 5B is a top view of the first and second side plates 108A, 108B of the device 100 enclosure in accordance with one example embodiment of the present disclosure. As shown in FIG. 5B, the exterior surface 520 of the side plates 108A, 108B is formed with a series of fins 522. The fins 522 provide a large surface area to facilitate the dissipation of heat from the internal components of the device 100. In the example embodiment, each fin 522 has a depth 523 of 0.2 inches, a width 524 of 0.08 inches and a length 525 of 1.51 inches. The dimensions and shape of the fins 522 may vary in other embodiments.

FIG. 5C shows a side view of the first and second side plates 108A, 108B of the device 100 enclosure in accordance with one example embodiment of the present disclosure. Each if the side surfaces 505, 507 of the first and second side plates 108A, 108B are a solid flat surface with one or more holes 514. The first and second side plates 108A, 108B are of a thickness to facilitate the heat dissipation of the internal components of the device 100. In the example embodiment shown, the first and second side plates 108A, 108B have a thickness of 0.565 inches.

FIG. 5D shows an interior view of the first and second side plates 108A, 108B of the device 100 enclosure in accordance with one example embodiment of the present disclosure. As shown in FIG. 5D, the protrusions 502, 504, 506 are located at different positions along the side plates 108A, 108B. In the example embodiment, there is a distance of 2.535 inches between protrusions 502 and 504, and a distance of 1.49 inches in between protrusions 504 and 506.

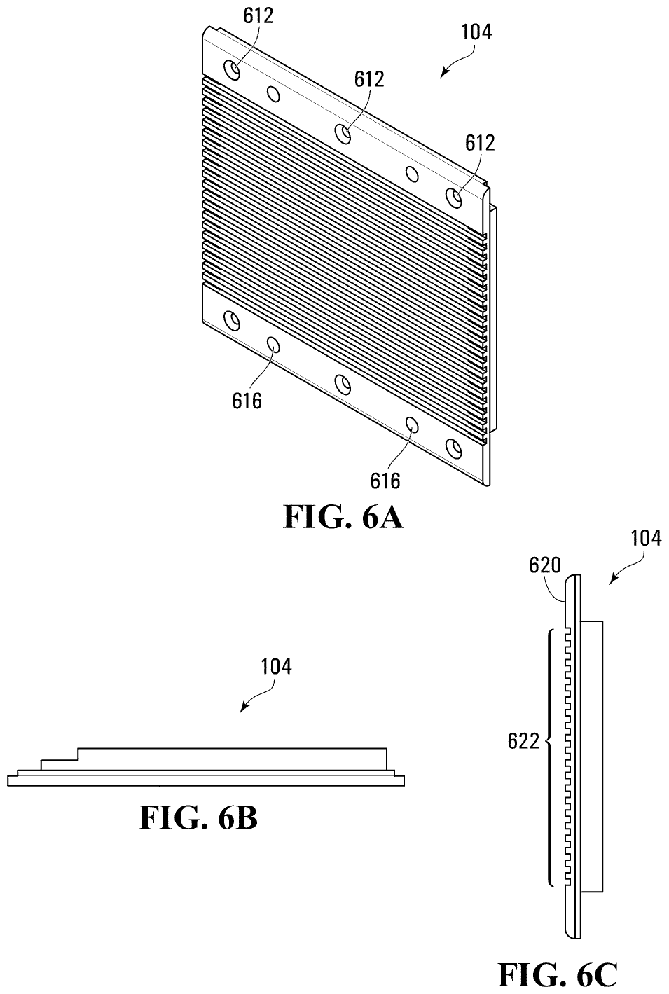

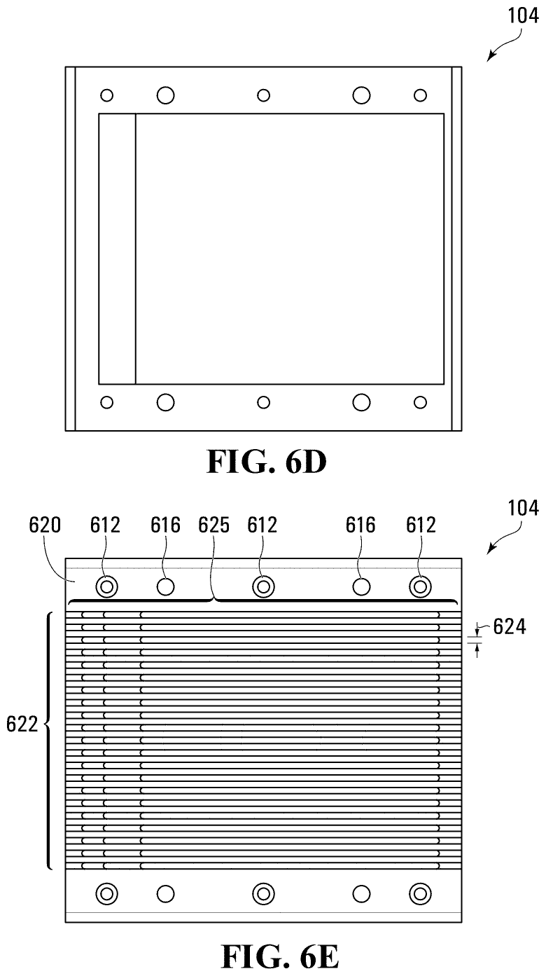

FIG. 6A shows a perspective view of the top plate 104 of the device 100 enclosure in accordance with one example embodiment of the present disclosure. The top plate 104 has one or more holes 612 on its top surface 603 that align with holes on the first and second side plates 108A, 108B that are used to secure the top plate 104 to the side plates 108A, 108B using screws. Also, the top plate 104 has a series of holes 616 that are used to mount the device 100 to its external environment (e.g. on the aircraft).

FIG. 6B shows a top view of the top plate 104 of the device 100 enclosure in accordance with one example embodiment of the present disclosure.

FIG. 6C shows a side view of the top plate 104 of the device 100 enclosure in accordance with one example embodiment of the present disclosure. The top plate 104 is of a thickness to facilitate the heat dissipation of the internal components of the device 100. In the example embodiment shown, the top plate 104 has a thickness of 0.195 inches. As shown in FIG. 6C, the exterior surface 620 of the top plate 104 is formed with a series of fins 622. The fins 622 provide a large surface area to facilitate the dissipation of heat from the internal components of the device 100.

FIG. 6D shows a back view of the top plate 104 of the device 100 enclosure in accordance with one example embodiment of the present disclosure. In the example shown FIGS. 6B and 6E, the top plate 104 has a length of 5.055 inches and a height of 4.64 inches.

FIG. 6E shows a front view of the top plate 104 of the device 100 enclosure in accordance with one example embodiment of the present disclosure. As shown in FIG. 6E, the exterior surface 620 of the top plate 104 has the series of fins 622. In the example embodiment, each fin 622 has a width 624 of 0.08 inches and a length 625 of 5.055 inches.

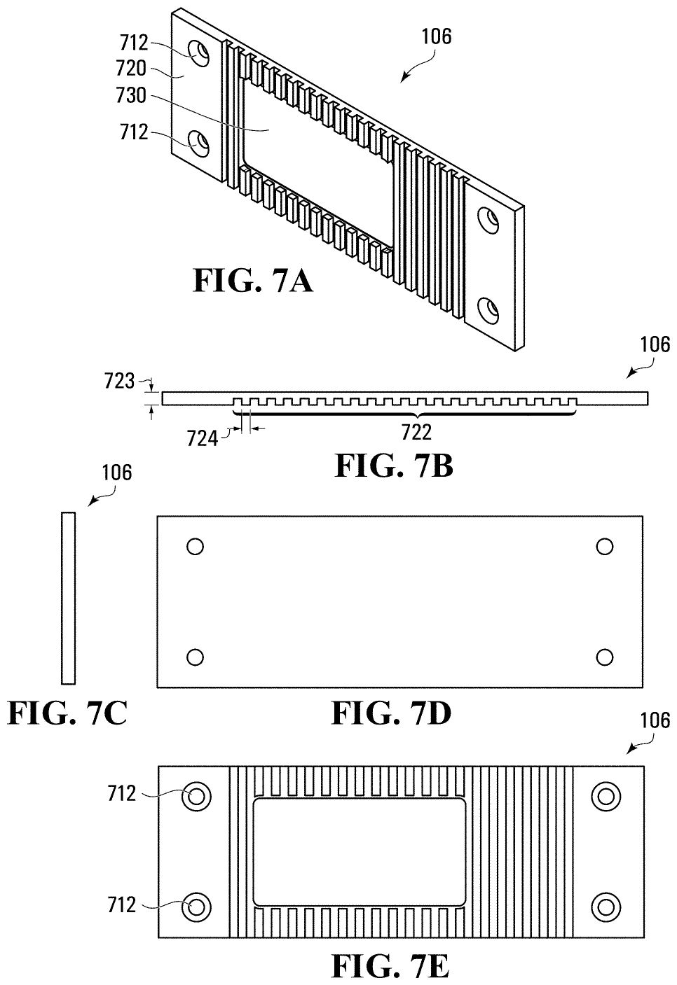

FIG. 7A shows a perspective view of the back plate 106 of the device 100 enclosure in accordance with one example embodiment of the present disclosure. The back plate 106 has one or more holes 712 on its external surface 720 that align with holes on the first and second side plates 108A, 108B that are used to secure the back plate 106 to the side plates 108A, 108B using screws. The back plate 106 is independently removable from the device 100 to provide access to test interfaces. As well, in some embodiments the back plate 106 may have a surface recess 730. A plate or other covering may be placed within the recess 730. For example, the covering may be used to display branding and technical or other information relating to the device 100.

FIG. 7B shows a top view of the back plate 106 of the device 100 enclosure in accordance with one example embodiment of the present disclosure. As shown in FIG. 7B, the exterior surface 720 of the back plate 106 is formed with a series of fins 722. The fins 722 provide a large surface area to facilitate the dissipation of heat from the internal components of the device 100. In the example embodiment, each fin 722 has a depth 723 of 0.063 inches and a width 724 of 0.08 inches.

FIG. 7C shows a side view of the back plate 106 of the device 100 enclosure in accordance with one example embodiment of the present disclosure. The back plate 106 is of a thickness to facilitate the heat dissipation of the internal components of the device 100. In the example embodiment shown, the back plate 106 has a thickness of 0.125 inches.

FIG. 7D shows a back view of the back plate 106 of the device 100 enclosure in accordance with one example embodiment of the present disclosure. In the example shown, the back plate 106 has a length of 4.64 inches and height of 1.64 inches.

FIG. 7E shows a front view of the back plate 106 of the device 100 enclosure in accordance with one example embodiment of the present disclosure.

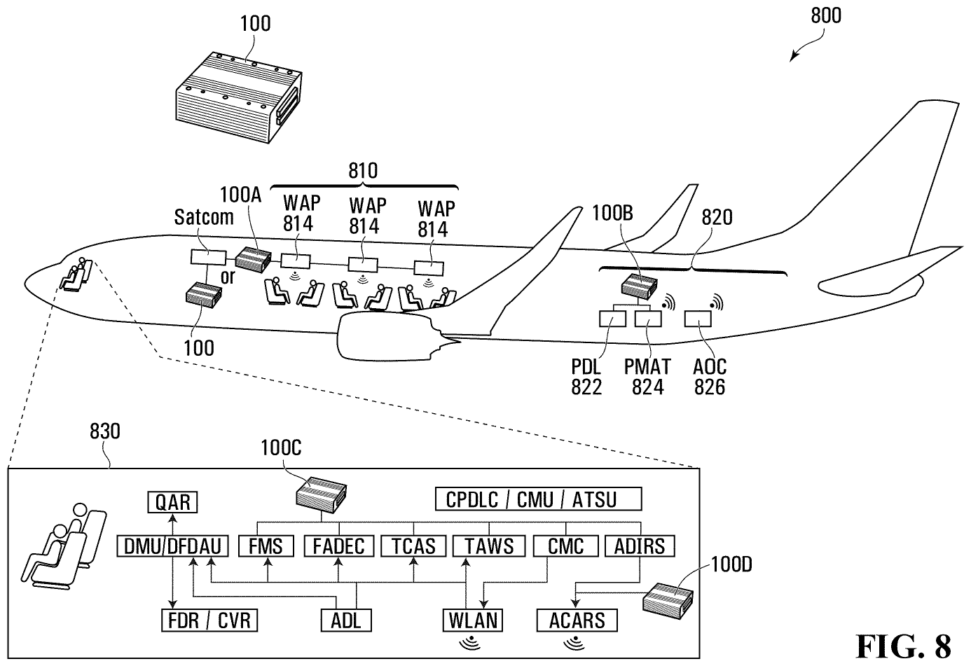

FIG. 8 shows the device 100 in an aircraft environment 800 in accordance with one example embodiment of the present disclosure. In the example embodiment, the device 100 has the size dimensions of 5″ L×4.5″ W×1.8″ H. In other embodiments, the size dimensions of the device 100 may vary depending on the type and number of internal components contained within the device and the heat dissipation requirements of these internal components. As well, in the example embodiment, the weight of the device 100 is less than three pounds (e.g. 1.36 kgs). Also, the device 100 in the example embodiment requires a 28 VDC input, however if other embodiments the power requirements of the device 100 may be higher or lower than this value (e.g. 14 VDC input). The device 100 may be installed in-line with networking (or networked) devices and avionics to monitor and protect the aircraft's onboard network (e.g. avionic network or avionic system). In the example shown, the device 100A is located in the passenger cabin and connected to the inflight entertainment system 810. The device 100A may be connected to a SATCOM 812 or wireless access points 814 on the aircraft 800. In the example shown, the device 100B is located in a maintenance area 820 of the aircraft 800. The device 100B may be connected to (wired or wirelessly) to portable data loaders (PDL) 822, portable maintenance access terminals (PMAT) 824, and aircraft operational control (AOC) 826. In the example shown, the devices 100C and 100D are located in the flight operations/pilot area 830 of the aircraft 800. The device 100C may be connected (wired or wirelessly) to various flight operation components, such as for example FMS, FADEC, TCAS, TAWS, CMC, ADIRS, DMU/DFDAU, QAR, FDR/CVR, ADL, CPDLC/CMU/ATSU, ACARS and WLAN.

The device 100 may be installed autonomously without live connectivity from the aircraft 800 to a secure ground server. The device 100 may include and provide for example an advanced firewall, log collection and storage, active data monitoring, a security database, an intrusion detection system (IDS), an intrusion prevention system (IPS) and machine to machine (M2M) encryption.

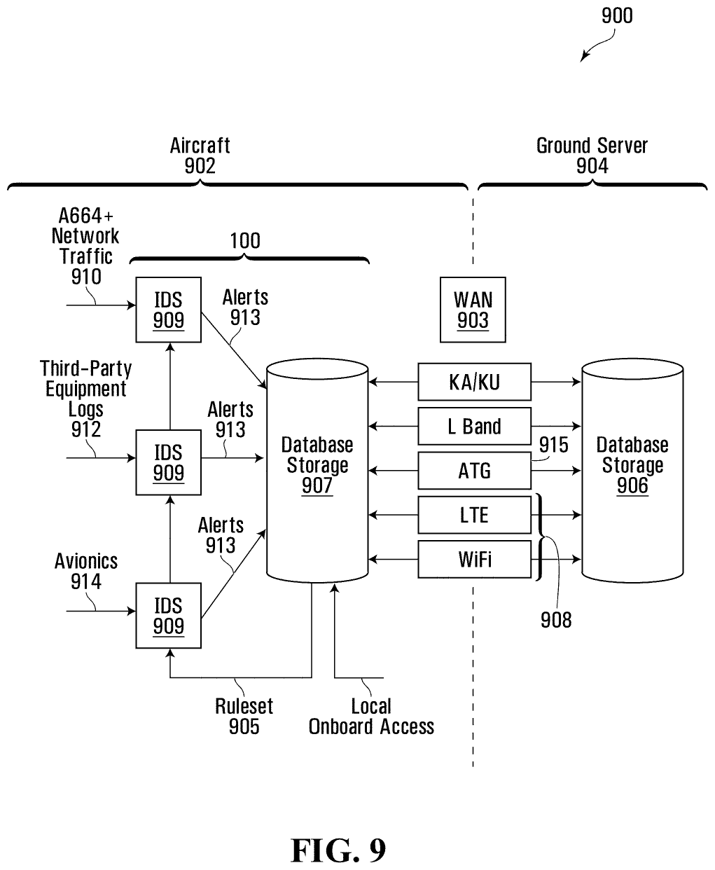

FIG. 9 shows a system diagram 900 of the device's 100 connectivity to other components in accordance with one example embodiment of the present application. The device 100 may include and provide for example a dynamic remote ruleset updates against the latest known vulnerabilities and attacks (e.g. cybersecurity threats), managed security operations centre (SOC), remote real-time firewall and policy—based routing updates, modern virtual private network (VPN) and remote technical support for all devices in the onboard network. The device 100 may be installed and connected with SATCOM or other connectivity from an aircraft 902 to a secure ground server 904. The device 100 includes memory (e.g. SSD, RAM) and database storage 907. In the example system diagram 900, the device 100 is located on the aircraft 902 and communicates with the ground server 904 having a memory 906 (e.g. database storage) via a wireless wide area network (WAN) 903. The device 100 may communicate with the ground server 904 via air-to-ground (ATG) communication 915, satellites, standard wireless communication protocols 908 such as for example, LTE and WiFi and via radio frequencies such as for example KA/KU and L BAND 911. The intrusion detection system 909 security software on the device 100 applies a ruleset 905 to incoming communications to determine if there are any security threats (e.g. network intrusion attempts, malware). Incoming aircraft communications may include network traffic 910, third-party equipment logs 912 and avionic information and messages 914. If an intrusion is detected, alerts 913 (and other related information) are sent to the ground server 904.

FIG. 11 is a perspective views of the device in accordance with another example embodiment of the present disclosure. As shown in FIG. 11, the device 1100 incorporates similar elements of the device 100 but functions as a flight controller and includes additional elements such as for example air intakes 1105 for pressure sensors.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations. Furthermore, to the extent that the term “includes” is used in either the detailed description or the claims, such term is intended to be inclusive in a manner similar to the term “comprising” as “comprising” is interpreted when employed as a transitional word in a claim.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. An avionic wireless access point device comprising:
a housing; and
one or more electronic components contained within the housing;
wherein the housing functions as a heat sink.

2. The device of claim 1, wherein the device is operable in non-pressurized environments.

3. The device of claim 1, wherein the device weighs less than three pounds.

4. The device of claim 1, wherein the housing is made of a high thermal conductivity material to dissipate heat.

5. The device of claim 1, wherein the external surface of the housing has a plurality of fins to dissipate heat.

6. The device of claim 1, wherein the one or more electronic components are positioned within the device in close proximity to the top and bottom surfaces of the housing

7. The device of claim 1, wherein the one or more electronic components are positioned in a stacked configuration within the housing.

8. The device of claim 1, wherein the device is connected in-line to networked devices in an avionic system.

9. The device of claim 1, wherein the one or more electronic components include a processor, a wireless interface and a memory.

10. The device of claim 9, wherein the processor is configured to:
apply a rule set to incoming communications to the avionic system to detect cybersecurity threats; and
transmit an alert regarding a detected cybersecurity threat to a ground server.

11. The device of claim 1, wherein the housing comprises:
a top plate;
a bottom plate;
a front plate;
a back plate; and
two side plates;
wherein the external surfaces of the top plate, the two side plates and the back plate have a plurality of fins to dissipate heat.

12. The device of claim 11, wherein the two side plates function as both a heat pipe and a heat sink.

13. The device of claim 11, wherein the top plate, the bottom plate and the two side plates each have one or more holes that align with each other for attachment of the device to another surface.

14. The device of claim 1, wherein there is near uniform thermal spread throughout the housing when the device is operating.

15. The device of claim 1, wherein the thickness of the housing is dependent on the amount of heat to be dissipated from the one or more electronic components in the device.

16. The device of claim 1, wherein the device meets the requirements of airborne equipment standard RTCA DO-160.

17. An wireless access point device for use with an avionic system, the device comprising:
a heat sink enclosure;
a communications subsystem contained within the enclosure; and
a processor contained within the enclosure, wherein the processor is configured to:
review incoming communications to the avionic system for cybersecurity threats; and
transmit, to a ground server, an alert regarding a detected cybersecurity threat.

18. The device of claim 17, wherein the incoming communications include avionic information, network traffic and equipment logs.
